(19) United States
(12) Patent Application Publication
(10) Pub. No.: US 2007/0085985 A1
(43) Pub. Date: Apr. 19, 2007

(54) Image projection system and light source device thereof

(76) Inventors: Sze-Ke Wang, Chu Nan (TW); Sheng-Tang Lai, Chu Nan (TW)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/528,923

(22) Filed: Sep. 28, 2006

(30) Foreign Application Priority Data
Oct. 13, 2005 (TW) 094135687

(51) Int. Cl. G03B 27/52; G03B 27/54; G03B 27/72

(52) U.S. Cl. 355/30; 355/37

(57) ABSTRACT

An image projection system includes a light source device for providing unified light, a light modulator for receiving and modulating the unified light, and a projection device for receiving and projecting the modulated light onto a screen. The light source device includes a light-emitting unit capable of generating source light, and a light-uniform unit that has a light entrance side disposed to receive the source light, and a light exit side disposed to permit the unified light to exit the light-uniform unit. The light exit side includes an active area and an overfill area surrounding the active area. The light source device further includes a reflecting unit disposed to cover the overfill area such that the unified light at the overfill area that impinges the reflecting unit is reflected back toward the light-uniform unit and the light-emitting unit.

### CROSS-REFERENCE TO RELATED APPLICATION

This application claims priority of Taiwanese Application No. 094135687, filed on Oct. 13, 2005.

### BACKGROUND OF THE INVENTION

1. Field of the Invention

The invention relates to an image projection system and a light source device thereof, more particularly to an image projection system and a light source device thereof capable of unifying light.

2. Description of the Related Art

As shown in FIG. 1, a conventional image projection system includes a light source device 11, an integrating rod 12, a lens unit 13, a light valve 14 (e.g., a digital micromirror device (DMD)), and a projector lens 15. The integrating rod 12 serves to unify source light provided by the light source device 11.

Two types of integrating rods include solid integrating rods and hollow integrating rods. The solid integrating rod utilizes total internal reflection (TIR) to unify light. On the other hand, the hollow integrating rod is formed by assembling a plurality of glass plates having highly-reflective inner plate surfaces, generally formed by providing a reflective coating thereon. The highly-reflective inner plate surfaces provide multiple reflections for light as the light travels in the hollow integrating rod, such that the light is unified before exiting the hollow integrating rod.

The integrating rod 12 is provided with an entrance side 121 disposed to permit source light provided by the light source device 11 to enter the integrating rod 12, and an exit side 122 disposed to permit unified light traveling through the integrating rod 12 to exit the integrating rod 12. Normally, the exit side 122 is configured such that unified light exits the integrating rod 12 toward the light valve 14 with a wider coverage than dimension of an active area of the light valve 14. This is to prevent interference signals or shadows in the active area of the light valve 14 due to optical and mechanical offsets that occurred during assembly of the conventional image projection system. The light valve 14 then modulates the unified light, and projects the modulated light onto a screen 16 via the projector lens 15.

The integrating rod 12 is sufficiently long to ensure higher efficiency in unifying light. However, the long integrating rod 12 results in a corresponding increase in the size of the conventional image projection system. In addition, number of reflections in the long integrating rod 12 also increases, resulting in greater energy loss for the unified light.

It has been proposed heretofore to use a shorter integrating rod but with a larger cross-sectional area in the conventional image projection system. The unified light exits such an integrating rod toward the light valve 14 onto a much wider area than the dimension of the active area of the light valve 14, as illustrated in FIG. 2, where the area bounded by the dashed lines represents illumination 17 of the unified light. Since the unified light has higher intensity and uniformity toward the center of illumination, by positioning the light valve 14 at the center of the illumination 17, the required length of the integrating rod can be reduced.

However, since the illumination 17 of the unified light that falls outside the active area of the light valve 14 is eventually wasted, overall light utilization is poor. Therefore, manufacturers are striving to achieve ways of reducing the length of the integrating rod, while ensuring uniformity of light reaching the screen 16 and improving light utilization.

### SUMMARY OF THE INVENTION

Therefore, the object of the present invention is to provide an image projection system and a light source device thereof capable of utilizing light normally wasted in the prior art.

According to one aspect of the present invention, an image projection system is provided and includes: a light source device for providing unified light; a light modulator having a light receiving side for receiving the unified light provided by the light source device, and operable so as to modulate the unified light; and a projection device for receiving modulated light from the light modulator and adapted for projecting the modulated light onto a screen. The light source device includes a light-emitting unit capable of generating source light, and a light-uniform unit having a light entrance side that is disposed to receive the source light from the light-emitting unit, and a light exit side that is disposed to permit the unified light to exit the light-uniform unit. The light exit side includes an active area and an over fill area surrounding the active area. The light source device further includes a reflecting unit disposed to cover the overfill area of the light exit side such that the unified light exits the light-uniform unit at the active area to project onto the light receiving side of the light modulator, and such that the unified light impinging the reflecting unit is reflected back toward the light-uniform unit and the light-emitting unit.

According to another aspect of the present invention, a light source device is provided and is adapted for providing unified light to a light modulator in an image projection system. The light source device includes a light-emitting unit capable of generating source light, and a light-uniform unit having a light entrance side that is disposed to receive the source light from the light-emitting unit, and a light exit side that is disposed to permit the unified light to exit the light-uniform unit. The light exit side includes an active area and an overfill area surrounding the active area. The light source device further includes a reflecting unit disposed to cover the overfill area of the light exit side such that the unified light exits the light-uniform unit at the active area to project onto the light modulator, and such that the unified light impinging the reflecting unit is reflected back toward the light-uniform unit and the light-emitting unit.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram of a conventional image projection system;

FIG. 2 is a schematic diagram illustrating a light valve projected by unified light in the conventional image projection system;

FIG. 3 is a schematic diagram of an image projection system according to a first preferred embodiment of the present invention;

FIG. 4 is an exploded perspective view of a light-uniform unit and a reflecting unit of a light source device according to the first preferred embodiment;

FIG. 5 is a sectional view of the reflecting unit in FIG. 4;

FIG. 6 is a sectional view illustrating a light-uniform unit and a reflecting unit of a modified light source device according to the first preferred embodiment of the present invention;

FIG. 7 is a schematic diagram illustrating path of light in the light source device according to the first preferred embodiment of the present invention;

FIG. 8 is a fragmentary schematic diagram of a light source device of an image projection system according to a second preferred embodiment of the present invention;

FIG. 9 is a schematic diagram of an image projection system according to a third preferred embodiment of the present invention;

FIG. 10 is a schematic diagram of an image projection system according to a fourth preferred embodiment of the present invention;

FIG. 11-1 is an experiment diagram illustrating result of a utilization efficiency test conducted for a control group;

FIG. 11-2 is an experiment diagram illustrating result of a utilization efficiency test conducted for an experiment group;

FIG. 12-1 is an experiment diagram illustrating result of a uniformity test conducted for a control group; and

FIG. 12-2 is an experiment diagram illustrating result of a uniformity test conducted for an experiment group.

### DETAILED DESCRIPTION OF THE PREFERRED EMBODIMENTS

Before the present invention is described in greater detail, it is noted herein that like elements are denoted by the same reference numerals throughout the disclosure.

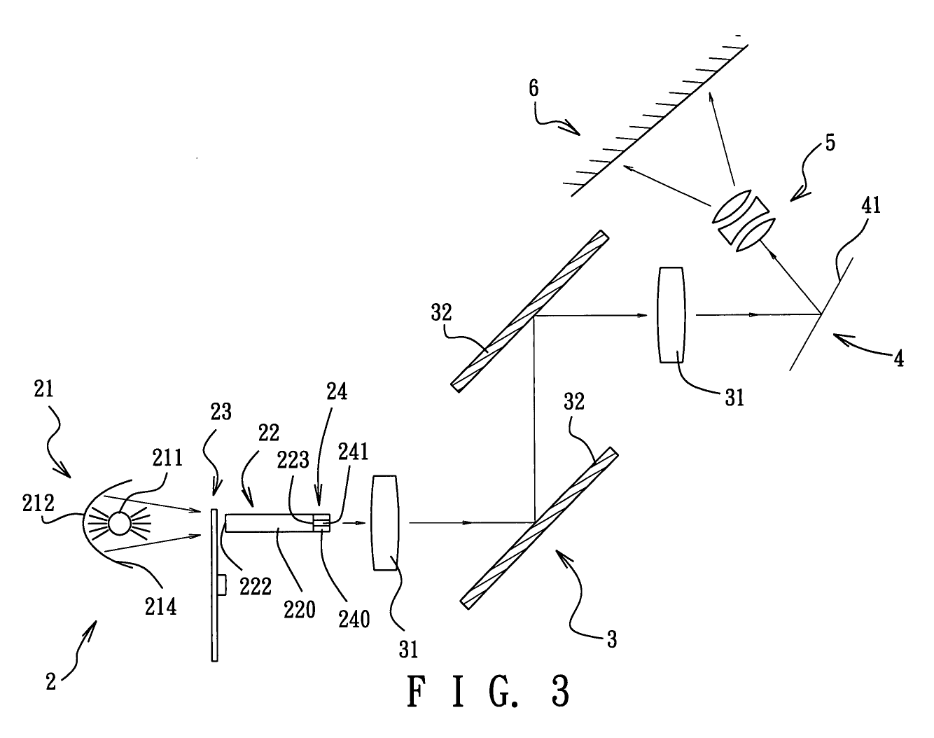

As shown in FIG. 3, an image projection system according to a first preferred embodiment of the present invention includes a light source device 2 for providing unified light, a lens unit 3, a light modulator 4 having a light-receiving side 41 for receiving the unified light provided by the light source device 2 and operable so as to modulate the unified light, and a projection device 5 for receiving modulated light from the light modulator 4 and adapted for projecting the modulated light onto a screen 6.

The light source device 2 includes a light-emitting unit 21, a light-uniform unit 22, a light-splitting unit 23, and a reflecting unit 24. In this embodiment, the light-emitting unit 21 includes a light-emitting member 211 capable of generating source light, e.g., a light bulb, and an elliptical reflector 212 having a reflective surface 214 for reflecting source light generated by the light-emitting member 211 toward the light-uniform unit 22.

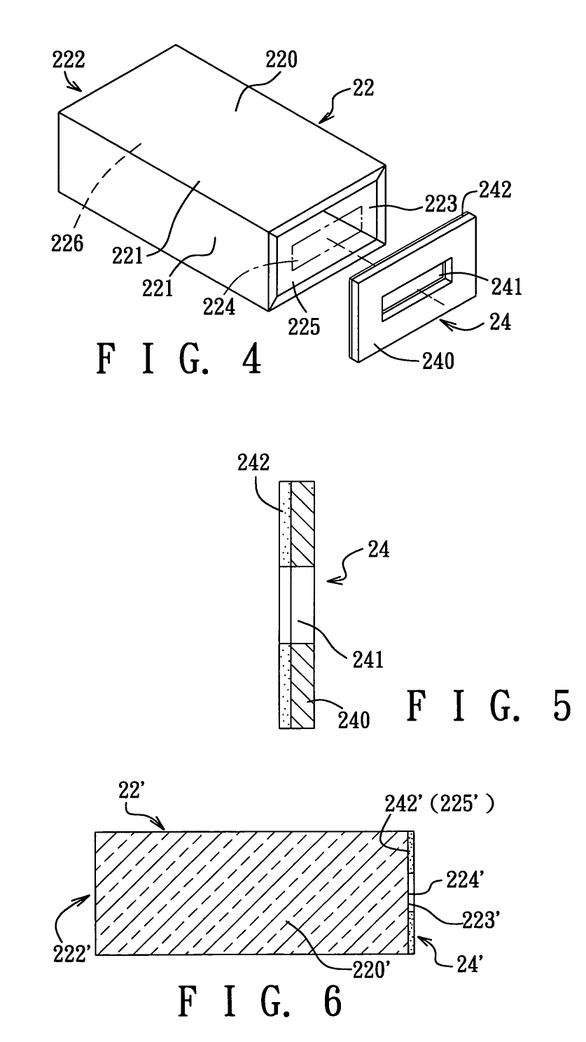

With further reference to FIG. 4, in this embodiment, the light-uniform unit 22 includes a hollow integrating rod 220. The hollow integrating rod 220 includes a plurality of side plates 221 that are assembled to confine a hollow chamber 226. Each of the side plates 221 is provided with a reflective inner wall surface, such as by providing a highly-reflective coating thereon. The hollow integrating rod 220 has a light entrance side 222 that is disposed to receive the source light from the light-emitting unit 21, and a light exit side 223 that is disposed to permit the unified light to exit the light-uniform unit 22. Each of the light entrance and light exit sides 222, 223 is an open side formed at a respective end of the hollow integrating rod 220, and is in spatial communication with the hollow chamber 226.

After the source light from the light-emitting unit 21 enters the hollow chamber 226 via the light entrance side 222, multiple reflections are provided by the reflective inner wall surfaces to the source light. The source light is reflected many times in the hollow integrating rod 220 so as to unify the source light before the light exits the hollow integrating rod 220 via the light exit side 223. The light exit side 223 includes an active area 224 and an overfill area 225 surrounding the active area 224, and has a shape that corresponds to the dimensions of the light-receiving side 41 of the light modulator 4. In this embodiment, the light exit side 223 is rectangular in shape.

Referring to FIG. 3 and FIG. 4, the light-emitting member 211 is disposed at one of the focal points of the elliptical reflector 212, while the light entrance side 222 of the hollow integrating rod 220 is disposed at the other one of the focal points of the elliptical reflector 212 such that the source light received by the light-uniform unit 22 is focused.

The light-splitting unit 23 is a color wheel in this embodiment, includes red, blue and green light filtering components, and is disposed proximate to the light entrance side 222 so as to split the source light, i.e., white light, into red, blue, and green source light components that enter the light-uniform unit 22 in sequence for homogenization. It is noted herein that the light-splitting unit 23 is disposed according to a particular requirement suitable for a specific design, and is not limited to that disclosed herein. For instance, the light-splitting unit 23 can be disposed proximate to the light exit side 223 for splitting the unified light into red, blue and green unified light components. As will be described later, the light-splitting unit 23 can be a beam splitter (e.g., a trichroic prism) that performs the same light-splitting function as the color wheel according to other embodiments of the present invention.

The reflecting unit 24 of the light source device 2 is disposed to cover the overfill area 225 of the light exit side 223 of the light-uniform unit 22 such that the unified light exits the light-uniform unit 22 at the active area 224 onto the light-receiving side 41 of the light modulator 4, and such that the unified light at the overfill area 225 that impinges the reflecting unit 24 is reflected back toward the light-uniform unit 22 and the light-emitting unit 21.

With further reference to FIG. 4 and FIG. 5, in this embodiment, the reflecting unit 24 includes a substrate 240 formed with an opening 241 that is registered with and that corresponds to the active area 224 of the light exit side 223 of the light-uniform unit 22. The substrate 240 is formed with a reflective surface 242 around the opening 241. Preferably, the substrate 240 is formed with a metal film and a dielectric film alternatively to result in the reflective surface 242. The reflective surface 242 is registered with and confronts the overfill area 225 of the light exit side 223 of the light-uniform unit 22, and reflects the unified light at the overfill area 225 that impinges the reflecting unit 24 back toward the light-emitting unit 21.

FIG. 6 illustrates the light-uniform unit 22′ and the reflecting unit 24′ of a modified light source device according to the first preferred embodiment. The light-uniform unit 22′ includes a solid integrating rod 220′ formed with the light entrance and light exit sides 222′, 223′. The reflecting unit 24′ includes a reflective layer 242′ that is formed directly on the light exit side 223′ and that is disposed to cover the overfill area 225′ of the light exit side 223′.

As shown in FIG. 8, a light source device 2″ of an image projection system according to a second preferred embodiment of the present invention differs from the first preferred embodiment in that the light-emitting unit 21″ of the light source device 2″ includes a light-emitting member 211″, a parabolic reflector 212″, and a condenser lens 213 disposed between the parabolic reflector 212″ and the light entrance side 222 of the light-uniform unit 22.

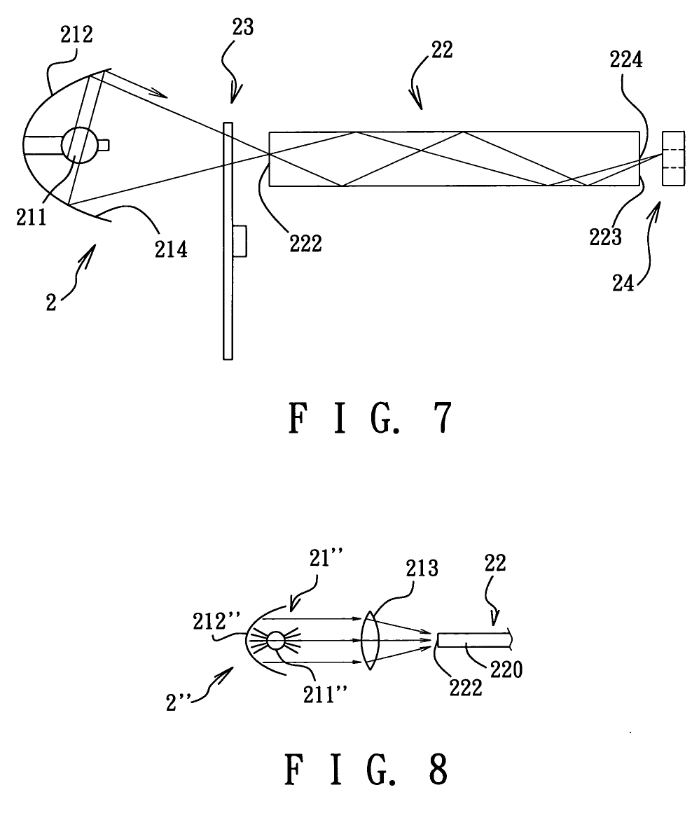

How the light source device 2 of the first preferred embodiment produces unified light is described with reference to FIG. 3 and FIG. 7. First, the light-emitting member 211 is disposed approximately at a primary focal point of the elliptical reflector 212. The light-emitting member 211 generates the source light in various directions, a major portion of which is reflected by the reflective surface 214 of the elliptical reflector 212 and is focused toward the light entrance side 222 of the light-uniform unit 22.

The source light is split into red, blue and green source light components by the filtering components of the light-splitting unit 23 (i.e., the color wheel) in sequence before entering into the light-uniform unit 22 via the light entrance side 222. Due to the internal reflections occurring inside the light-uniform unit 22, the red, blue, and green source light components are transformed in sequence into the unified light before exiting the light-uniform unit 22 via the light exit side 223.

The unified light that exits the light-uniform unit 22 at the active area 224 (as shown in FIG. 4) of the light exit side 223 is refracted by the lens unit 3 to project onto the light receiving side 4 of the light modulator 4. The unified light that reaches the overfill area 225 of the light exit side 223 and that impinges the reflecting unit 24 is reflected back toward the light-emitting unit 21.

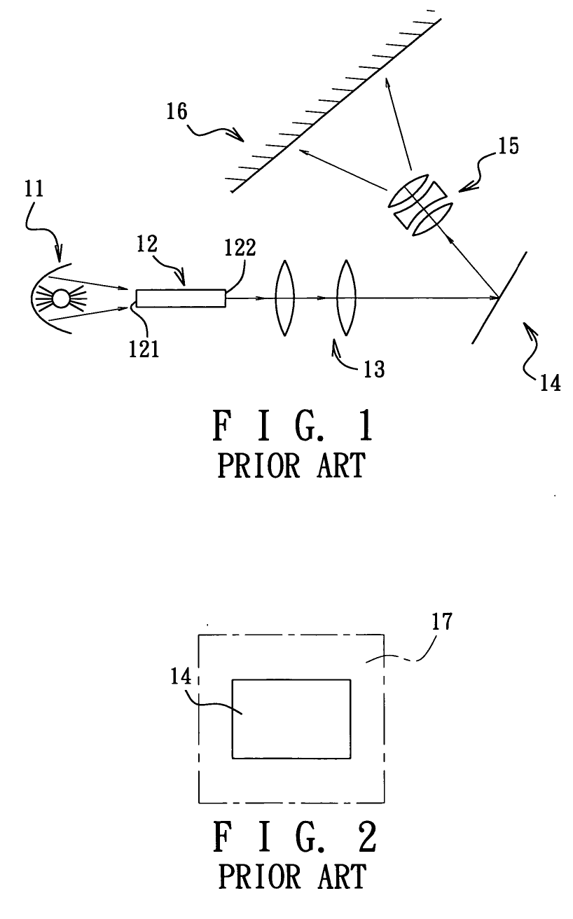

The unified light exiting said light-uniform unit at the overfill area 225 is reflected back toward the light-emitting unit 21 to be reflected once again by the elliptical reflector 212, to be unified once more by the light-uniform unit 22, and to be projected onto the light-receiving side 41 of the light modulator 4 after it exits the light-uniform unit 22 via the active area 224. The unified light at the overfill area 225 impinging the reflecting unit 24 is reflected back toward light-uniform unit 22 and the light-emitting unit 21 to propagate in the light-uniform unit at least twice before exiting the light-uniform unit 22 via the active area 224 of the light exit side 223, such that the uniformity thereof is improved accordingly. Therefore, unlike the integrating rod 12 in the conventional image projection system (as shown in FIG. 1), it is not necessary to increase the length of the light-uniform unit 22. In addition, unlike the conventional image projection system that uses the shorter integrating rod but with the larger cross-sectional area than those according to the present invention, where a major portion of the unified light is wasted (as shown in FIG. 2), most of the unified light is eventually utilized to project onto the light modulator 4 of the image projection system according to this invention.

It is noted herein that the geometry of the active and the overfill areas 224, 225 is determined with respect to the dimensions of the active area of the light-receiving side 41 of the light modulator 4 in such a manner that the active area of the light-receiving side 41 is completely projected by the unified light. In addition, the geometry of the active and overfill areas 224, 225 in this embodiment is for the purpose of illustration only. Those skilled in the art are able to appreciate that the reflective surface 242 can be slightly smaller than the overfill area 225 to permit compensation of optical and mechanical offsets in the image projection system. Positions of the active and overfill areas 224, 225, as well as the reflective surface 242, depend on design criteria of a particular image projection system, and are not limited to those disclosed in this embodiment.

Referring again to FIG. 3, the lens unit 3 includes two transparent lenses 31 for transmitting the unified light without diffusion or dispersion toward the light modulator 4, and two reflective mirrors 32 disposed between the transparent lenses 31 for bending the propagation direction of the unified light. Since the feature of the present invention does not reside in the lens unit 3, further details of the same are omitted herein for the sake of brevity.

The light modulator 4 is a digital micromirror device (DMD) in this embodiment. The DMD is composed of thousands of microscopic mirrors, each of which corresponds to one pixel in a projected image. Each of the microscopic mirrors is mounted on a tiny hinge to permit individual tilting movements in accordance with corresponding pixel data. Pixel data of a digital image determine on and off states of the microscopic mirrors, in which microscopic mirrors reflect the light toward and away from the projection device 5, respectively. In this embodiment, the unified light is modulated by the DMD due to reflective properties thereof.

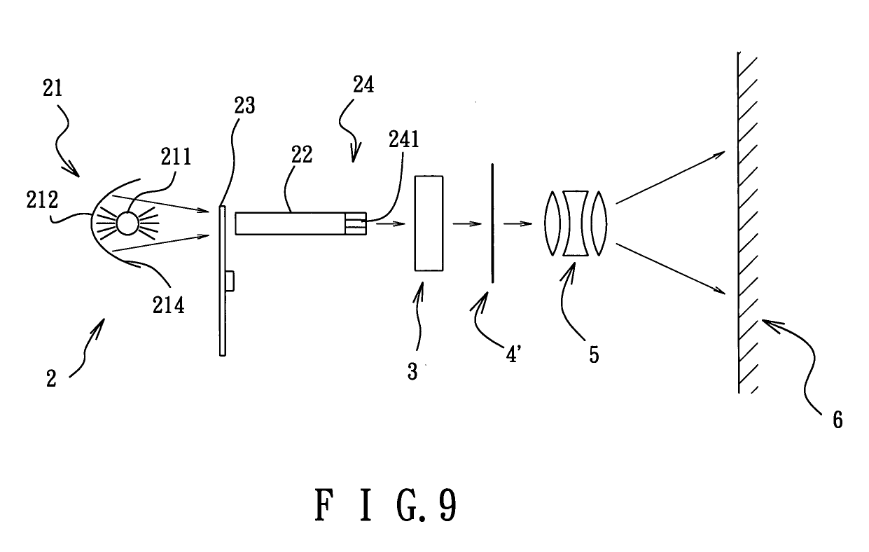

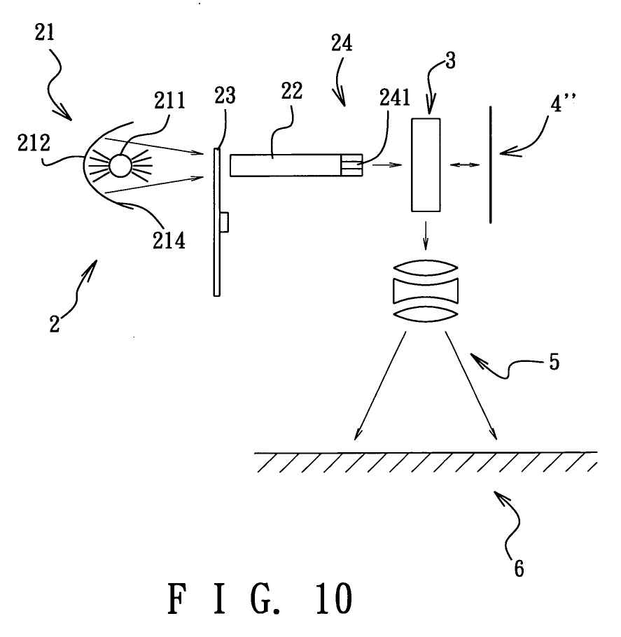

As shown in FIG. 9, the light modulator 4′ can be a transmissive liquid crystal device according to a third preferred embodiment of the present invention. The unified light is modulated by the liquid crystals in the transmissive liquid crystal device by adjusting the amount of light transmitted therethrough. As shown in FIG. 10, the light modulator 4″ can be a reflective liquid crystal device (e.g., a liquid crystal on silicon (LCOS)) according to a fourth preferred embodiment of the present invention. The reflective liquid crystal device is made by applying liquid crystals directly on the surface of a highly-reflective mirror substrate. As the liquid crystals are individually activated or deactivated, light can be either reflected by the substrate or blocked by the liquid crystals.

Referring back to FIG. 3, the projection device 5 can be a zoom lensor an universal focus lens, but is not limited to this particular aspect. It is noted herein that since the feature of the present invention does not reside in the specifics of the light modulator 4 and the projection device 5 described hereinabove, further details thereof are omitted herein for the sake of brevity.

Described hereinbelow are results of an experiment conducted to illustrate effects and advantages of the present invention. A control group, representing the prior art, uses a 15 mm×6.15 mm×4.5 mm (length×width×height) hollow integrating rod (not shown). An experiment group, representing the present invention, uses a reflecting unit (not shown) in addition to a 15 mm×6.15 mm×4.5 mm (length ×width×height) hollow integrating rod (not shown),which has an active area of 5.1 mm×3.55 mm (width×height). The reflecting unit is disposed to cover the overfill area, which surrounds the active area, as described hereinabove. The rest of the setup is identical to that of the first preferred embodiment. In other words, the sole difference between the control group and the experiment group is in the absence and presence of the reflecting unit. Two tests were conducted in this experiment, i.e., utilization efficiency test and uniformity test. The experimental results are illustrated in FIGS. 11-1 to 12-2.

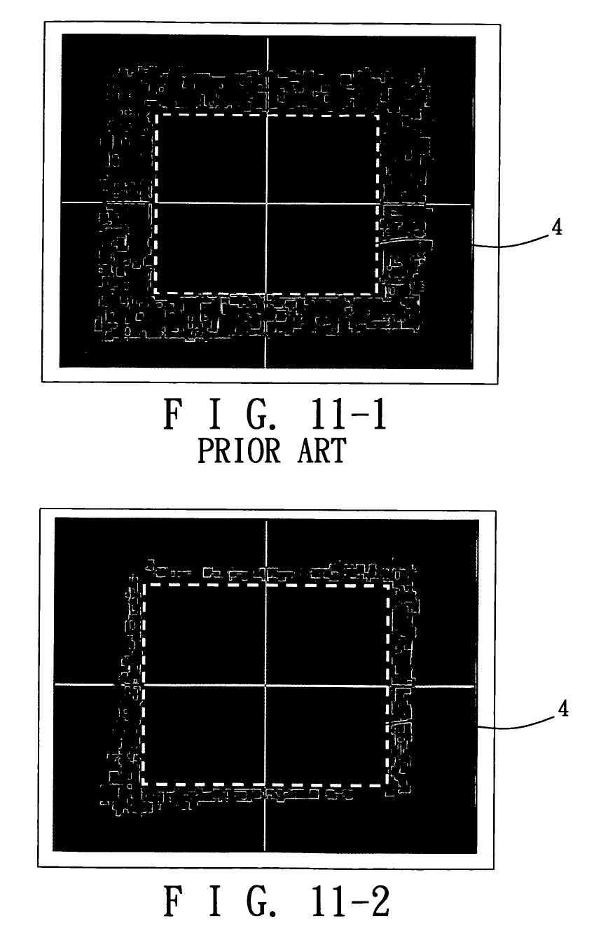

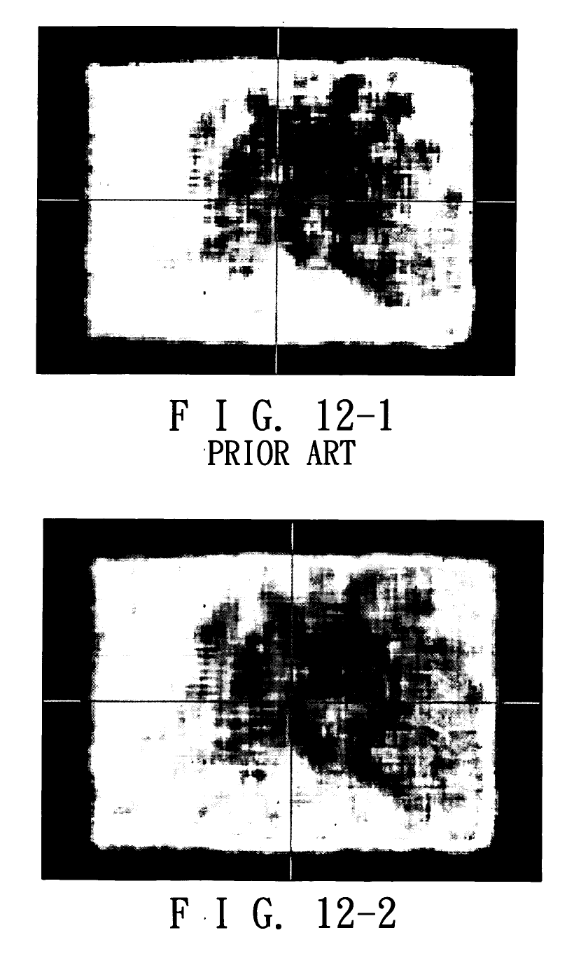

With reference to FIG. 3, when the light source unit 21 generates the source light with 100% output efficiency, the utilization efficiency of the unified light reaching the light modulator 4 (i.e., the DMD) of the control group is 37.4% (refer to FIG. 11-1, the area surrounded by the dashed lines represent the light modulator 4), and the utilization efficiency of the modulated light reaching the screen 6 is 30% (refer to FIG. 12-1). On the other hand, the utilization efficiency of the unified light reaching the light modulator 4 of the experiment group is 46.3% (refer to FIG. 11-2, the area surrounded by the dashed lines represent the light modulator 4), and the utilization efficiency of the modulated light reaching the screen 6 is 37.6% (refer to FIG. 12-2). Therefore, it is evident from this experiment that the present invention increases the utilization efficiencies of the unified light and the modulated light reaching the light modulator 4 and the screen 6, respectively. Referring to FIG. 11-1 and FIG. 11-2, the reflecting unit 24 according to the present invention is used for reducing the amount of wasted unified light.

In order to conduct the uniformity test, the screen 6 is first divided into nine equally sized sections. The average illumination of each section is calculated individually to search for the brightest and the dimmest sections. Lastly, illumination ratio between the brightest and dimmest sections is calculated. Referring to FIG. 12-1 and FIG. 12-2, the uniformity of the control group is 49.55%, while that of the experiment group is 55.41%. Therefore, it is evident that the present invention aids in increasing the uniformity of illumination.

In sum, due to the presence of the reflecting unit 24 (as shown in FIG. 3) at the light exit side 223 of the light-uniform unit 22, the unified light that reaches the overfill area 225 of the light exit side 223, which is wasted in the prior art, is reflected back toward the light-emitting unit 21 via the light-uniform unit 22 for further unifying, and then eventually reaches the light modulator 4 and the screen 6 promoting the utilization efficiency and uniformity.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. An image projection system comprising:
a light source device for providing unified light;
a light modulator having a light receiving side for receiving the unified light provided by said light source device, and operable so as to modulate the unified light; and
a projection device for receiving modulated light from said light modulator and adapted for projecting the modulated light onto a screen;
wherein said light source device includes a light-emitting unit capable of generating source light, and a light-uniform unit having a light entrance side that is disposed adjacent to said light-emitting unit to receive the source light from said light-emitting unit, and a light exit side that is disposed to permit the unified light to exit said light-uniform unit;
wherein said light exit side includes an active area and an overfill area surrounding said active area;
wherein said light source device further includes a reflecting unit disposed to cover said overfill area of said light exit side such that the unified light exits said light-uniform unit at said active area to project onto said light receiving side of said light modulator, and such that the unified light at said overfill area that impinges said reflecting unit is reflected back toward said light-uniform unit and said light-emitting unit.

2. The image projection system as claimed in claim 1, wherein said light-uniform unit includes a hollow integrating rod and a solid integrating rod alternatively.

3. The image projection system as claimed in claim 1, wherein said reflecting unit includes a substrate formed with an opening that is registered with and that corresponds to said active area of said light exit side of said light-uniform unit, said substrate being formed with a reflective surface around said opening, said reflective surface being registered with and confronting said overfill area of said light exit side of said light-uniform unit.

4. The image projection system as claimed in claim 3, wherein said substrate is formed with a metal film and a dielectric film alternatively to result in said reflective surface.

5. The image projection system as claimed in claim 1, wherein said light-uniform unit includes a solid integrating rod having said light entrance and light exit sides, and said reflecting unit includes a reflective layer that is formed on said light exit side and that is disposed to cover said overfill area of said light exit side.

6. The image projection system as claimed in claim 1, wherein said light modulator is selected from the group consisting of a reflective liquid crystal device, a transmissive liquid crystal device, and a digital micromirror device.

7. A light source device adapted for providing unified light to a light modulator in an image projection system, said light source device comprising:
a light-emitting unit capable of generating source light;
a light-uniform unit having a light entrance side that is disposed adjacent to said light-emitting unit to receive the source light from said light-emitting unit, and a light exit side that is disposed to permit the unified light to exit said light-uniform unit and that includes an active area and an overfill area surrounding said active area; and
a reflecting unit disposed to cover said overfill area of said light exit side such that the unified light exits said light-uniform unit at said active area to project onto the light modulator, and such that the unified light at said overfill area that impinges said reflecting unit is reflected back toward said light-uniform unit and said light-emitting unit.

8. The light source device as claimed in claim 7, wherein said light-emitting unit includes an elliptical reflector.

9. The light source device as claimed in claim 7, wherein said light-emitting unit includes a parabolic reflector and a condenser lens disposed between said parabolic reflector and said light entrance side of said light-uniform unit.

10. The light source device as claimed in claim 7, wherein said light-uniform unit includes a hollow integrating rod and a solid integrating rod alternatively.

11. The light source device as claimed in claim 7, wherein said reflecting unit includes a substrate formed with an opening that is registered with and that corresponds to said active area of said light exit side of said light-uniform unit, said substrate being formed with a reflective surface around said opening, said reflective surface being registered with and confronting said overfill area of said light exit side of said light-uniform unit.

12. The light source device as claimed in claim 11, wherein said substrate is formed with a metal film and a dielectric film alternatively to result in said reflective surface.

13. The light source device as claimed in claim 7, wherein said light-uniform unit includes a solid integrating rod having said light entrance and light exit sides, and said reflecting unit includes a reflective layer that is formed on said light exit side and that is disposed to cover said overfill area of said light exit side.
